(19) United States
(12) Patent Application Publication
(10) Pub. No.: US 2004/0007324 A1
(43) Pub. Date: Jan. 15, 2004

(54) Method for producing document cards comprising several layers and document cards produced therewith

(76) Inventors: Ralf Henn, Hardert (DE); Dirk Fischer, Borchen (DE); Matthias Schumacher, Borchen (DE)

Correspondence Address: Fulbright & Jaworski, Twenty-Ninth Floor, 865 South Figueroa Street, Los Angeles, CA, 90017-2571, US

(21) Appl. No.: 10/296,567

(22) PCT Filed: Apr. 12, 2001
(86) PCT No.: PCT/EP01/04232

(30) Foreign Application Priority Data
May 20, 2000 (DE) 100 25 093.9

(51) Int. Cl. B42D 15/00; B32B 7/14; B32B 3/10; C09J 1/00; B32B 31/00; C09J 7/00

(52) U.S. Cl. 156/327; 283/74; 283/107; 428/195.1; 428/203; 156/182; 156/313

(57) ABSTRACT

The invention relates to a method for producing a multi-layer document card, especially an identity card made of plastic, comprising several layers. Said card comprises a card core with at least one card core layer, a protective layer on at least one side of said card core, and adhesive layers between the individual card layers. The card core is printed on either on one or two sides. The method is carried out in the following manner:

The printed layers of the card core are prepared,

the protective layers are prepared,

the adhesive layers are applied to the individual protective and/or core layers,

the individual card layers are precisely positioned one on top of the other,

the card layers are joined together in a lamination press with the aid of pressure and heat.

An adhesive system which is cross-linked under the effect of pressure and/or heat, comprising a thermoplastic synthetic component and a cross-linking component, is used in at least one adhesive layer.

The invention relates to a method for producing multi-layer document cards, especially multi-layer identity cards made of plastic, with said card comprising a card core with at least one card core layer, a protective layer on at least one side of said card core, and adhesive layers between the individual card layers, and with the card core being printed on either on one or two sides; the method comprises the following process steps: preparing the printed layer(s) of the card core, preparing the protective layers, applying the adhesive layers to the individual protective and/or core layers, positioning the individual card layers precisely one on top of the other, and joining the card layers together in a lamination press with the aid of pressure and heat; as well as a two-pack adhesive system and identity cards produced therewith.

Multi-layer identity cards are widely used in the form of check and banker's cards as well as identity documents. More often than not such cards are provided with a magnetic strip or integrated circuit (semiconductor component, chip). Identity cards with chip are termed chip cards or smart cards. In this manner multi-layer identity cards with chip are frequently used to provide authorized access to GSM mobile radio systems where the identity card owner identifies themselves towards the mobile network operator as authorized subscriber by inserting their identity card (GSM card) into the mobile terminal device.

For the card layers—card core layers as well as protective layers—various materials can be put to use: polyvinyl chloride (PVC), polycarbonate (PC), acrylic nitrile-butadiene-styrole (ABS), polyethylene terephthalate (PET, PETG, PETF). For identity documents paper core layers are customarily used. The choice of materials and the card build-up are governed by various factors. These factors are, for example, the desired mechanical properties of the identity card to be produced, its behavior in response to high or low temperatures, the question whether the material can be printed on, the question whether the card can be printed on via laser, as well as economical and ecological necessities.

Multi-layer identity cards are produced by initially making available the card core with imprints on one or two sides. The card core comprises either one card core layer with imprints on one or two sides or two card core layers of which at least one outward facing side has been printed on. Following this, the protective layers of the card are prepared. All layers are bonded together with the aid of a lamination press.

To bring about an adequate bonding action between the individual layers adhesive coats are applied as a rule. To bond the card core layers together one of these layers is also coated with adhesive material. For the purpose of applying the protective layers the adhesive coating may either be put on the back of the protective layers or on the card core layer already provided with an imprint.

Adhesive materials that are currently in use are preferably formulations prepared on the basis of polyurethanes, polyesters or polyamides and/or their copolymers. In particular thermoplastic adhesive formulations are used. A cross-linking of these thermoplastic adhesive materials by way of subjecting them to high-energy radiation is a known method but requires an additional processing step and also involves a risk in that the plastic and/or adhesive materials used for the product may undergo detrimental changes. Attention is drawn in particular to the fact that a number of plastic materials tend to discolor when subjected to high-energy radiation.

The use of covalently cross-linked adhesive systems has not been disclosed hitherto. However, especially such covalently cross-linked adhesive material formulations are expected to enhance the strength of the bond and, particularly, improve the temperature resistance and resistance to solvents.

Indeed, of special interest is an improved temperature resistance, on the one hand, to prevent the cards from deforming/changing under the influence of heat as already encountered with existing systems if cards placed behind the windshield of a motor car are subjected to sunlight. But what is more, a non-destructive delamination of the printed card and protective layers shall also be prevented on a long-term basis to rule out a falsification and abuse of such identity cards.

Consequently, the objective underlying the invention is to provide a method and adhesive material system suited to enable a durable and particularly temperature and solvent resistant bond of the individual layers of a multi-layer document, in particular an identity card, to be achieved.

What is to be achieved, inter alia, is an increase of the strength of the bond between protective layer and printed-on card core layer superior to formulations hitherto used so that a non-destructive delamination of the bonded foils is positively ruled out.

This objective is fulfilled by providing a method of the type described above wherein in at least one adhesive layer an adhesive system cross-linked under the influence of pressure and/or heat is used that has a thermoplastic synthetic component and a cross-linking component.

Furthermore, the invention relates to a two-pack adhesive system which may in particular be used for the production of multi-layer identity cards of plastic and comprises of a thermoplastic hot-melt adhesive component and a separate cross-linking component; such adhesive system is capable of being cross-linked through the application of pressure and/or heat.

The invention is described below taking identity cards of plastic as an example. However, the same applies analogously to all multi-layer documents such as data media, identity documents, value documents and the like, which have a core made of plastic or some other material.

Thermoplastic adhesive systems are preferably used for the production of cards to be used for numerous applications since they are superior to other products as far as workability, bonding strength and temperature resistance are concerned. Nevertheless, such adhesive systems have certain impairments which for the main part are due to the fact that their behavior is reversible under the influence of temperature and solvents. According to the present invention such impairments can be overcome.

In the light of the adhesive system the characteristics and embodiments of the invention are described in detail hereunder for the method and for the adhesive system.

The adhesive system to be used according to the invention is, in particular, a thermoplastic synthetic material with double bonds combined with a peroxide. Preferred thermoplastic synthetic materials with double bond are polyamides, especially polycondensates that are formed as a result of diamines reacting with dimerized fatty acids. As initial or basic product polyfunctional amines, such as, for example, ethylene diamine or polyethylene amines are used as a rule that are caused to undergo a reaction with higher dicarboxylic acids, preferably dimerized fatty acids from linoleic acid, oleic acid or tall oil fatty acid. The thermoplastic polyamides known by the term polyamide resins are obtained by polycondensation. Aside from these (homo)polyamides of a more or less clearly defined molecular structure appropriate copolyamides of a specific characteristic profile can be built up by varying the initial or basic products (various diamines, amino carboxylic acids and their lactames with other dicarboxylic acids) as well as their interrelationship. However, a prerequisite for the usability of such polyamide resins according to the invention is that their molecular structure still contains a C═C double bond. Basically, all thermoplastic polyamide resins that still contain C═C double bonds can be used for purposes in the framework of the invention.

According to the invention it is provided that these still existing double bonds are used for cross-linking in a radical chain reaction. The radical starter molecules/cross-linking agents used for this purpose consist of peroxides and act as initiators of the radical polymerization. According to the respective processing temperature the following organic peroxide compounds are suited, Inter alia, as so-called radical starters:

methyl ethyl keton peroxide (˜80° C.)

dibenzoyl peroxide (˜100° C.)

di-tert-butyl peroxide (˜150° C.)

cumol hydroperoxide (˜180° C.)

tertiary butyl peroxy benzoate (˜130° C.)

tertiary butyl hydroperoxide (˜200° C.).

It is of special advantage if the processing temperature of the hot-melt adhesive (softening temperature or lamination temperature) corresponds to the activation temperature of the radical starter. In this manner the lamination temperature required for the relevant hot-melt adhesive can at the same time be utilized for the activation of the radical starter. With a typical processing temperature in the range of between 130 and 150° C. thermoplastic resins of double-bonding nature having a softening temperature within this range could therefore be put to use together with dibenzoyl peroxide, di-tert-butyl peroxide or tertiary butyl peroxy benzoate. Adhesive systems consisting of these components will only be activated and cross-linked when the lamination temperature takes effect whereas at normal temperatures they are stable and can be processed in the usual manner.

The reaction diagram showing the carbon-carbon cross-linking of a thermoplastic resin with dibenzoyl peroxide as radical starter is indicated below.

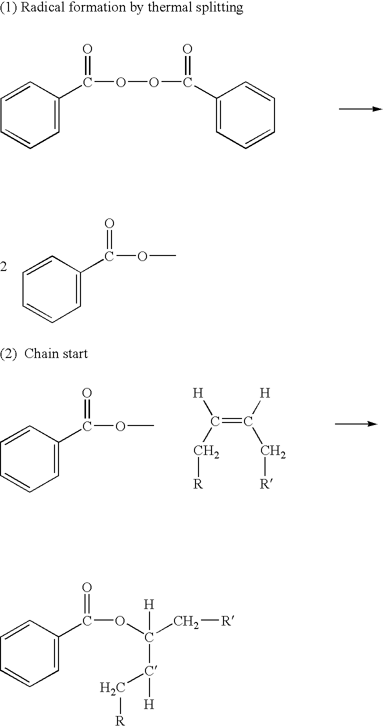

Depending on the nature of the monomers underlying the polycondensate, the rests R and R′, respectively, are, e.g.:

—(CH₂)ₙ—CONH—R″, n=2-9,

a dimerized linolic acid rest

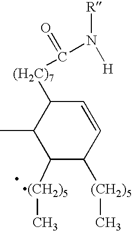

Here the rest R″ represents further chain forming units of the polyamine resin.

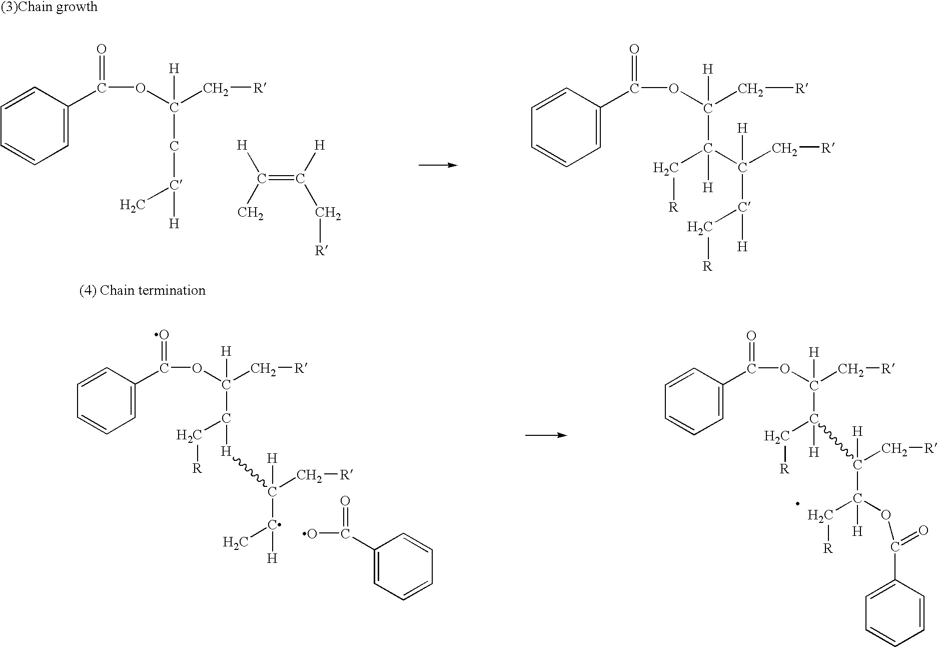

Preferably, the activation temperature for the peroxide to be used as prescribed by the invention is 60° C. or higher. In particular, it is in the range of between 80 and 250° C.

Useful hot-melt adhesives according to the invention, especially those on the basis of unsaturated polyurethanes, polyesters and polyamides, expediently have a softening point in the range of between 80 and 250° C. and a melting viscosity at 160° C. of 50,000 to 110,000 mPa.s in accordance with ASTMD3236. Especially preferred is a softening temperature that ranges between 100 and 160° C.

In the event the thermoplastic synthetic material is an unsaturated polyamide condensates stemming from unsaturated dimeric fatty acids are preferred. Eligible for use as polyamides are in particular ethylene diamine, diethylene triamine and alkylene diamine with up to 12 C atoms. Especially preferred are condensates obtained from unsaturated dimerized linoleic acid with one of these polyamides that satisfy the above mentioned marginal conditions with respect to the softening point and melting viscosity characteristics.

The adhesive system contains, as a rule, between 1 and 10% by weight of peroxide as radical starter, in particular 2 to 5% by weight, each based on the unsaturated thermoplastic adhesive. For the coating of the card layers the adhesive system is normally used in solution, with suitable solvents being, for example, toluene and isopropanol. The coating methods and quantities are of customary nature and known to those skilled in the art.

A further advantage of the method and adhesive system is in particular that the adhesive system contains the thermoplastic synthetic material component and the cross-linking component in the form of a mixture that is only activated when elevated temperatures take effect.

According to another preferred embodiment of the invention the adhesive system contains, side by side, a polyisocyanate component and a thermoplastic resin component that reacts with it and contains active hydrogen.

In this variant of the invention the adhesive formulation employed utilizes the reactivity of the isocyanate component for the cross-linking of the adhesive layer. The second resin component has free functional groups with hydrogen atoms that are reactive towards isocyanate functions with said atoms being available as participants in the reaction of the isocyanate groups for the polyaddition. These are, in particular, hydroxyl groups and amino groups. The two components, however, do not react at room temperature or while the adhesive is being processed but only when a critical temperature level has been exceeded which is the case when the identity card undergoes lamination. For this purpose the activation and processing temperatures indicated for the adhesive system on the basis of unsaturated thermoplastic adhesives and peroxides shall apply.

The polyisocyanate component of the adhesive system thus contains a polyisocyanate on the basis of hexamethylene diisocyanate (HDI), isophorone diisocyanate (IPDI), toluylene diisocyanate (TDI), diphenyl methane diisocyanate (MDI) or the like. For this purpose and to achieve an appropriate optical quality and elasticity of the adhesive bond especially aliphatic diisocyanate compounds are preferred that exhibit only a minor tendency towards yellowing.

The polyisocyanate may be present in the form of a monomer, but, on principle, also as a prepolymer, that is partially cross-linked with the aid of a customary cross-linking agent. Such polymers are known and in any case contain at least two reactive isocyanate groups per molecule/chain to enable the reaction to be continued. Customary cross-linking agents for the formation of prepolymers are glycols, polyetherols and polyesterols but also polyamines.

To prevent a premature reaction of the adhesive system (already at room temperature) the polyisocyanate component has been blocked. For this purpose two methods are available as follows.

In the event a chemical blocking or capping method is employed the NCO groups used are caused to react using customary blocking agents which are again split off at a temperature level higher than the deblocking temperature. Using an HBL blocking agent the reaction takes place as shown below:

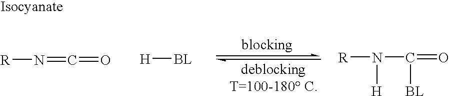

In this case as well the adhesive system at room temperature represents a stable system comprising two components. By selecting the appropriate blocking agent the blocking temperature can be varied. Moreover, the deblocking temperature can be lowered through the use of catalysts. The following blocking agents may be employed:

Phenol (140 to 180° C.)

ε-Caprolactam (160 to 180° C.)

Butanonoxim (135 to 155° C.)

Malonic ester (100 to 130° C.).

The blocking process may also be brought about by a special method, i.e. by the dimerization of isocyanate groups to form urethdion, with such dimerization taking place catalytically according to the following scheme.

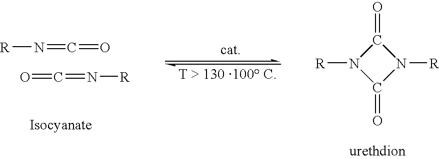

During such an “internal” blocking process the isocyanate at the same time serves as blocking agent offering the advantage that no blocking agent will be set free during deblocking and thus cannot impair the adhesive power of the adhesive system.

Blocking of the polyisocyanate may also be accomplished with the aid of mechanical means, i.e. by a microencapsulation of the isocyanate component. In any case the adhesive system is present in the form of a suspension of two components, i.e. of the microencapsulated isocyanate component within the cross-linking agent that both cannot be mixed with each other. Only if a critical temperature is exceeded will the encapsulation be reversed; the release of the polyisocyanate which is then thoroughly mixed with the cross-linking agent enables the cross-linking reaction to take place.

The encapsulation of the isocyanate component can be achieved per se by known methods, for example by a partial reaction of the isocyanate groups with diamines or polyamines. In this case prepolymers are produced in the form of polyurethane resins, which envelope residual polyisocyanate in the form of microscopic particles and isolate it from the environment.

When the microencapsulated isocyanate component is integrated into the adhesive system a stable system comprising two components is obtained which reacts only at temperatures above approx. 80 to 100° C. after the polyurethane has melted off or dissolved.

As resin component and reactant for the polyisocyanates all forms of polyols and higher molecular-weight and thermoplastic polyamines can be employed, for example polyetherols, polyesterols, OH functional poly(meth)acrylates and -urethane or NH₂ functional polyamides. Especially suited is a number of OH functional resins such as for example polyacrylate resins having a molar mass ranging between 2000 and 6000 g/mol and an OH content of between 1 and 5% by weight, saturated polyester having a molar mass of between 500 and 6000 g/mol and an OH content between 1 and 8% by weight and polyether having a molar mass of between 500 and 3000 g/mol and an OH content between 1 and 12% by weight.

The reaction diagram in this case is as follows:

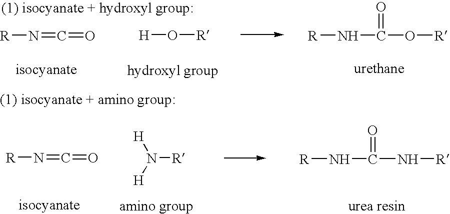

According to the invention the cross-linking density may be adjusted via the proportion of reactive groups in such a way that the thermoplastic character of the adhesive layer disappears but the required elasticity is maintained.

Even with this embodiment of the method and adhesive system according to the invention the lamination temperature and activation temperature for the adhesive system are matched to each other in such a manner that activation takes place automatically as soon as the lamination temperature is reached. This will then initiate the cross-linking of the thermoplastic synthetic material of the adhesive system.

As mentioned above, the adhesive system in this case may also be processed in the form of a solution in, for example, toluene; however, the liquid nature of the thermoplastic synthetic material component may be utilized as a rule to apply the system.

The adhesive systems according to the invention may contain customary additives in order to influence stability and workability or reduce the activation temperature, for example. Especially silicate may be employed as filler material because this will enable a thixotropic setting of the adhesive system to be achieved which will make it easier to apply it to the card layers.

Finally, the invention relates to a multi-layer identity card made of a synthetic material which comprises of a card core with at least one card core layer imprinted on one or two sides, one protective layer on each side of the card core as well as adhesive layers between the individual card layers, with said identity card being provided according to the above described method or by making use of the above described adhesive system.

The use of the cross-linked adhesive system according to the invention in particular leads to an increase of the temperature resistance and bonding strength of objects stuck together with it. Of material importance for such an improved property profile is that an initially purely thermoplastic reversible adhesive system has been transposed into a system featuring a cross-linked structure. Adhesive systems of this kind increase the security with a view to preventing manipulation, e.g. by a delamination of individual protective layers in laminated identity cards.

Furthermore, the adhesive systems according to the invention may also be used to laminate or foil-coat magnetic strips, holograms, signature strips and other applications on cards and identity documents. In such cases as well they are advantageously employed with a view to providing a higher bonding strength, temperature and solvent resistance to protect against manipulations and abuse.

Moreover, the adhesive systems may be used in all technical fields where a durable cross-linking of the adhesive layer will be of benefit.

1. Method for producing multi-layer document cards, especially a multi-layer identity card made of plastic, comprising several layers, with said card comprising a card core with at least one card core layer, a protective layer on each side of said card core, and adhesive layers between the individual card layers, and with the card core being imprinted either on one or on two sides; the method is carried out in the following manner:
The printed layer(s) of the card core are prepared,
the protective layers are prepared,
the adhesive layers are applied to the individual protective and/or core layers,
the individual card layers are precisely positioned one on top of the other,
the card layers are joined together in a lamination press with the aid of pressure and heat;
characterized in that, an adhesive system which is cross-linked under the effect of pressure and/or heat, comprising a thermoplastic synthetic component and a cross linking component, is used in at least one adhesive layer.

2. The method according to claim 1, characterized in that the adhesive system comprises a thermoplastic synthetic material with double bonds and one peroxide.

3. The method according to claim 2, characterized in that the peroxide has an activation temperature of 60° C. or above.

4. The method according to claim 2 or 3, characterized in that the peroxide has an activation temperature ranging between 80° C. and 250° C.

5. The method according to at least one of the claims 2 to 4, characterized in that the thermoplastic synthetic material is an unsaturated polyamide.

6. The method according to claim 5, characterized in that the unsaturated polyamide is a condensate from polyamines and unsaturated dimeric fatty acids.

7. The method according to claim 6, characterized in that the unsaturated dimeric fatty acid is a dimerized linoleic acid.

8. The method according to claim 1, characterized in that the adhesive system contains, side by side, a polyisocyanate component and a plastic component that reacts with it and contains active hydrogen.

9. The method according to claim 8, characterized in that the polyisocyanate is a polyisocyanate on the basis of HDI, IPDI, TDI or MDI.

10. The method according to claim 8 or 9, characterized in that the polyisocyanate is present in partially cross-linked condition with a polyamine.

11. A method according to at least one of the claims 8 to 10, characterized in that the isocyanate groups of the polyisocyanate are blocked.

12. The method according to claim 11, characterized in that the polyisocyanate deblocks at 60° C. or higher.

13. Method according to claims 11 or 12, characterized in that the polyisocyanate deblocks at a temperature ranging between 80 and 250° C.

14. The method according to at least one of the claims 11 to 13, characterized in that the polyisocyanate is blocked with phenol, E-Caprolactam, butanonoxim or malonic ester.

15. The method according to at least one of the claims 11 to 13, characterized in that the polyisocyanate is blocked by dimerization to form urethdion.

16. The method according to at least one of the claims 11 to 13, characterized in that the polyisocyanate is blocked mechanically by microencapsulation.

17. The method according to at least one of the claims 8 to 16, characterized in that the plastic component is a polyesterpolyol, polyetherpolyol, OH functional polyacrylate resin or polyamine.

18. Two-pack adhesive system especially for the production of multi-layer documents, particularly identity cards of plastic material, said system comprising of a thermoplastic hot-melt adhesive component and a separate cross-linking component, characterized in that the adhesive system is capable of being cross-linked through the application of pressure and heat.

19. The adhesive system according to claim 18, characterized in that the adhesive system comprises a thermoplastic synthetic material with double bonds and one peroxide.

20. The adhesive system according to claim 19, characterized in that the peroxide has an activation temperature of 60° C. or above.

21. The adhesive system according to claim 19 or 20, characterized in that the peroxide has an activation temperature ranging between 80° C. and 250° C.

22. The adhesive system according to at least one of the claims 19 to 21, characterized in that the thermoplastic synthetic material is an unsaturated polyamide.

23. The adhesive system according to claim 22, characterized in that the unsaturated polyamide is a condensate from polyamines and unsaturated dimeric fatty acids.

24. The adhesive system according to claim 6, characterized in that the unsaturated dimeric fatty acid is a dimerized linoleic acid.

25. The adhesive system according to claim 18, characterized in that the adhesive system contains, side by side, a polyisocyanate component and a cross-linking component that reacts with it and contains active hydrogen.

26. The adhesive system according to claim 25, characterized in that the polyisocyanate is a polyisocyanate on the basis of HDI, IPDI, TDI or MDI.

27. The adhesive system according to claim 25 or 26, characterized in that the polyisocyanate has been partially cross-linked with a polyamine.

28. An adhesive system according to at least one of the claims 25 to 27, characterized in that the isocyanate groups of the polyisocyanate are blocked.

29. The adhesive system according to claim 28, characterized in that the polyisocyanate has a deblocking temperature of 60° C. or higher.

30. The adhesive system according to claim 28 or 29, characterized in that the deblocking temperature ranges between 80 and 250° C.

31. The adhesive system according to at least one of the claims 28 to 30, characterized in that the polyisocyanate is blocked with phenol, E-Caprolactam, butanonoxim or malonic ester.

32. The adhesive system according to at least one of the claims 28 to 30, characterized in that the polyisocyanate is blocked by dimerization to form urethdion.

33. The adhesive system according to at least one of the claims 28 to 30, characterized in that the polyisocyanate is blocked mechanically by microencapsulation.

34. The adhesive system according to at least one of the claims 25 to 33, characterized in that the plastic component is a polyesterpolyol, polyetherpolyol, OH functional polyacrylate resin or polyamine.

35. Multi-layer document card, especially an identity card made of plastic, comprising a card core with at least one card core layer, with said card core being printed on either on one or two sides, a protective layer on at least one side of said card core, and adhesive layers between the individual card layers, characterized in that said identity card being provided according to the method specified under at least one of the claims 1 to 17.

36. Multi-layer document card, especially an identity card made of plastic, comprising a card core with at least one card core layer, with said card core being printed on either on one or two sides, a protective layer on at least one side of said card core, and adhesive layers between the individual card layers, characterized in that at least one of the adhesive layers is produced with the aid of an adhesive system according to at least one of the claims 18 to 34.
